(19) United States
(12) Patent Application Publication
(10) Pub. No.: US 2010/0190633 A1
(43) Pub. Date: Jul. 29, 2010

(54) PHOTOCATALYTIC COATING

(76) Inventors: Feng Bai, Woodbury, MN (US); Rachael A.T. Gould, Forest Lake, MN (US); Mark T. Anderson, Woodbury, MN (US)

Correspondence Address: 3M INNOVATIVE PROPERTIES COMPANY, PO BOX 33427, ST. PAUL, MN, 55133-3427, US

(21) Appl. No.: 12/519,844

(22) PCT Filed: Dec. 17, 2007
(86) PCT No.: PCT/US07/87698

§ 371 Date: Mar. 24, 2010

Related U.S. Application Data
(60) Provisional application No. 60/871,576, filed on Dec. 22, 2006.

(51) Int. Cl. B01J 21/06; B01J 21/16; B01J 23/04

(52) U.S. Cl. 502/63

(57) ABSTRACT

In one aspect, the present invention is directed to a coating composition. The coating composition comprises a dispersion of photocatalysts having a mean cluster size of less than about 300 nm and an alkali metal silicate binder. In another aspect, the present invention is directed to a coated article. The coated article has a photocatalytic coating with improved transparency on its external surface that is formed from the aforesaid coating composition.

### FIELD OF INVENTION

The present invention relates to a coating composition and a coated article having a photocatalytic coating formed therefrom, particularly with application to building materials, such as, for example, roofing granules.

### BACKGROUND

Discoloration of construction surfaces due to algae growth or other agents has been a problem for the construction industry for many years. Discoloration has been attributed to the presence of blue-green algae and other airborne contaminants, such as soot and grease.

One approach to combating this problem is to coat the construction surfaces with a composition that contains photocatalysts and a binder, typically a silicate binder. When exposed to sunlight, the photocatalysts may photo-oxidize the organic materials that cause the discoloration.

Photocatalytic titanium dioxide (TiO₂) particles can be used, for example, in roofing granules, to provide photocatalytic activity. Suitable TiO₂ particles are often very small, having a mean particle size in the range of about 1 nm to about 1000 nm. Such particles have strong surface interactions due to their high surface-to-volume ratios and without any treatment they tend to aggregate to form larger clusters. As a consequence, a relatively high amount of TiO₂ particles need to be used to achieve an acceptable level of photoactivity. This usually makes the coated granules pastel in color and thus lose aesthetic appeals.

### SUMMARY

The present invention is directed to a coating composition and a coated article resulting from the application of the coating composition.

The coating composition of the present invention generally includes a dispersion of photocatalysts having a mean cluster size of less than about 300 nm and an alkali metal silicate binder. The dispersion can be made by mixing the photocatalysts, a dispersant and a solvent. Preferably, the photocatalysts are transition metal oxides. Particularly preferred photocatalysts include crystalline anatase TiO₂, crystalline rutile TiO₂, crystalline ZnO and combinations thereof. The coating composition has a solid weight percentage of photocatalysts in the range of about 0.1% to about 90%. Preferred weight percentage is in the range of about 30% to about 80%. Examples of suitable dispersants include inorganic acids, inorganic bases, organic acids, organic bases, anhydrous or hydrated organic acid salts and combinations thereof. Suitable solvents can be any solvents that dissolve the dispersant used. Examples of suitable alkali metal silicate binders include lithium silicate, sodium silicate, potassium silicate, and combinations thereof.

Applying the coating composition onto a base article, followed by heating to elevated temperatures in a rotary kiln, oven or other suitable apparatus, produces a photocatalytic coating with improved transparency that exhibits desirable photoactivity. Preferred articles include building materials susceptible to discoloration due to algae growth or other agents, such as airborne particulates of dust, dirt, soot, pollen or the like. One particularly preferred article is roofing granules.

### DETAILED DESCRIPTION

The present invention is directed to a coating composition comprising a dispersion of photocatalysts having a mean cluster size of less than about 300 nm and an alkali metal silicate binder and a coated article having a photocatalytic coating with improved transparency. In the present invention, the transparency of a photocatalytic coating is characterized by measuring the difference in the L*, a*, b* numbers between the coated article and the base article, and preferably each of the absolute values of the difference measured is less than about 2. The L*, a*, b* numbers indicate color scales in light-dark, red-green, and yellow-blue, respectively, and all three numbers are needed to describe the color of an object. For two different objects, the difference in their L*, a*, b* numbers represents the difference in their colors.

The photocatalytic coating is formed by applying the coating composition onto the base article, followed by heating to elevated temperatures of at least about 170° C. and up to about 650° C., with a preferred temperature of about 200° C. to about 450° C. The coating protects the base article against discoloration caused by algae growth or other agents. For purposes of the present invention, the coating may have multiple layers.

Base articles suitable for use with the present invention can be any ceramic, metallic, or polymeric materials or composites thereof that are capable of withstanding temperatures of at least about 170° C. Preferred articles include building materials that are susceptible to discoloration due to algae infestation or other agents, such as airborne particulates of dust, dirt, soot, pollen or the like. Examples include roofing materials, concrete and cement based materials, plasters, asphalts, ceramics, stucco, grout, plastics, metals or coated metals, glass, or combinations thereof. Additional examples include pool surfaces, wall coverings, siding materials, flooring, filtration systems, cooling towers, buoys, seawalls, retaining walls, boat hulls, docks, and canals. One particularly preferred article is roofing granules, such as those formed from igneous rock, argillite, greenstone, granite, trap rock, silica sand, slate, nepheline syenite, greystone, crushed quartz, slag, or the like, and having a particle size in the range from about 300 μm to about 5000 μm in diameter. Roofing granules are often partially embedded onto a base roofing material, such as, for example, asphalt-impregnated shingles, to shield the base material from solar and environmental degradation. Another particularly preferred article is tiles, such as those formed from ceramics, stones, porcelains, metals, polymers, or composites thereof. Tiles are often used for covering roofs, ceilings, floors, and walls, or other objects such as tabletops to provide wear, weather and/or fire resistances.

The coating composition of the present invention comprises a dispersion of photocatalysts. Upon activation or exposure to sunlight, the photocatalysts are thought to establish both oxidation and reduction sites. These sites are thought to produce highly reactive species such as hydroxyl radicals that are capable of preventing or inhibiting the growth of algae or other biota on the coated article, especially in the presence of water.

The dispersion can be made, for example, by mixing the photocatalysts, a dispersant and a solvent. Many photocatalysts conventionally recognized by those skilled in the art are suitable for use with the present invention. Preferred photocatalysts include transition metal photocatalysts. Examples of suitable transition metal photocatalysts include TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, and combinations thereof. Particularly preferred photocatalysts include crystalline anatase TiO₂, crystalline rutile TiO₂, crystalline ZnO and combinations thereof. To improve spectral efficiency, the photocatalysts may be doped with a nonmetallic element, such as C, N, S, F, or with a metal or metal oxide, such as Pt, Pd, Au, Ag, Os, Rh, RuO₂, Nb, Cu, Sn, Ni, Fe, or combinations thereof.

Suitable dispersants may be inorganic acids, inorganic bases, organic acids, organic bases, anhydrous or hydrated organic acid salts and combinations thereof. Examples of inorganic acids include binary acids such as hydrochloric acid; and oxoacids such as nitric acid, sulfuric acid, phosphoric acid, perchloric acid and carbonic acid. Examples of inorganic bases include ammonia and hydroxides of lithium, sodium, potassium, rubidium, and cesium. Examples of organic acids include monocarboxylic acids such as formic acid, acetic acid and propionic acid; dicarboxylic acids such as oxalic acid, glutaric acid, succinic acid, malonic acid, maleic acid and adipic acid; tricarboxylic acids such as citric acid; and amino acids such as glycine. Examples of organic bases include urea, purine and pyrimidine. Examples of organic acid salts include ammonium carboxylates such as ammonium acetate, ammonium oxalate and ammonium hydrogen oxalate, ammonium citrate and ammonium hydrogen citrate; and carboxylic acid salts such as oxalates and hydrogen oxalates of lithium, sodium and potassium, and oxalates of magnesium, yttrium, titanium, zirconium, vanadium, chromium, molybdenum, tungsten, manganese, iron, cobalt, nickel, ruthenium, rhodium, palladium, osmium, iridium, platinum, copper, silver, gold, zinc, gallium, indium, germanium, tin, lanthanum, and cerium.

Suitable solvents can be any solvents that dissolve the dispersant used. Examples include water-based solvents such as water and hydrogen peroxide water; alcohols such as ethanol, methanol, 2-propanol and butanol; ketones such as acetone and 2-butanone; paraffin compound solvents; and aromatic compound solvents.

The photocatalysts in the dispersion may aggregate to form clusters owing to their surface interactions. The clusters formed have a mean size of less than about 300 nm. Mean cluster size can be determined by light scattering. Mean cluster size is different from mean particle size. Mean particle size characterizes individual particles of photocatalysts and is often measured using electron microscopy. Examples of commercially available TiO₂ dispersions that have a mean cluster size of less than about 300 nm include the STS-21 dispersion (available from Ishihara Sangyo Kaisha, Japan) and the W2730X dispersion (available from Degussa AG, Germany). The use of such dispersion in the present invention produces photocatalytic coatings with improved transparency that exhibit desirable photoactivity.

The coating composition has a solid weight percentage of photocatalysts in the range of about 0.1% to about 90%. Preferred weight percentage is in the range of about 30% to about 80%.

Examples of suitable alkali metal silicate binders include lithium silicate, sodium silicate, potassium silicate, and combinations thereof. Alkali metal silicate is generally denoted as M₂O:SiO₂, where M is lithium, sodium, or potassium. The weight ratio of SiO₂ to M₂O may range from about 1.4:1 to about 3.75:1. A preferred weight ratio is in the range of about 2.75:1 to about 3.22:1.

A pigment, or a combination of pigments, may be included in the coating composition to achieve a desired color. Suitable pigments include conventional pigments, such as carbon black, titanium oxide, chromium oxide, yellow iron oxide, phthalocyanine green and blue, ultramarine blue, red iron oxide, metal ferrites, and combinations thereof.

The durability of the photocatalytic coating of the present invention can be enhanced by adding an alkoxysilane (as disclosed in 3M Patent Application No. 62043US002, filed on Dec. 22, 2006, the entirety of which is incorporated herein by reference) and/or by adding a boric acid, borate, or combination thereof (as disclosed in 3M Patent Application No. 62617US002, filed on Dec. 22, 2006, the entirety of which is incorporated herein by reference) to the coating composition.

### EXAMPLES

The operation of the present invention will be further described with regard to the following detailed examples. These examples are offered to further illustrate the various specific and preferred embodiments and techniques. It should be understood, however, that many variations and modifications may be made while remaining within the scope of the present invention.

Measurement of Mean Cluster Size

The mean cluster size of the STS-21 dispersion of TiO₂ was measured using a Nanosizer (Nano-ZS series, available from Malvern Instruments, United Kingdom). The procedure for measuring the mean cluster size is as follows. About 0.02 g of the dispersion was diluted with 30 g of deionized water. The diluted dispersion was well shaken and then about 3 ml of the diluted dispersion was transferred into a 10-ml plastic syringe that is fitted with a 4.5-μm filter. The filtered dispersion was then used to measure the mean cluster size. This process was repeated twice, and the average of the three measurements was reported.

Measurement of L*, a *, b* Numbers

The granules were placed into a round sample holder with a diameter of 3 inches. The granules were then pressed so that they were flat and even with the edges of the holder. The holder was placed into a LabScan XE spectrophotometer (HunterLab, Reston, Va.), and a scan was taken. The holder was then emptied and reloaded, and another scan was taken. The two scans were averaged to produce the L*, a*, b* numbers of the granules.

Photocatalytic Activity Test

The granules were sieved through a −16/+20 mesh, washed 5 times by deionized water and then dried at 240° F. (˜116° C.) for about 20 minutes. 40 g of the dried granules was placed into a 500 mL crystallization dish. 500 g of 4×10⁻⁴ M aqueous disodium terephthalate solution was then added to the dish. The mixture was stirred using a magnetic bar placed in a submerged small Petri dish and driven by a magnetic stirrer underneath the crystallization dish. The mixture was exposed to UV light produced by an array of 4, equally spaced, 4-ft (1.2-m) long black light bulbs (Sylvania 350 BL 40W F40/350BL) that were powered by two specially designed ballasts (Action Labs, Woodville, Wis.). The height of the bulbs was adjusted to provide about 2.3 mW/cm² UV flux measured using a VWR Model 21800-016 UV Light Meter (VWR International, West Chester, Pa.) equipped with a UVA Model 365 Radiometer (Solar Light Company, Glenside, Pa.) having a wavelength band of 320-390 nm.

During irradiation, about 3 mL of the mixture was removed with a pipet at about 5-minute intervals and transferred to a disposable 4-window polymethylmethacrylate or quartz cuvette. The mixture in the cuvette was then placed into a Fluoromax-3 spectrofluorimeter (Jobin Yvon, Edison, N.J.). The fluorescence intensity measured at excitation wavelength of 314 nm and emission wavelength of 424 nm was plotted against the irradiation time. The slope of the linear portion (the initial 3-5 data points) of the curve was indicative of the photocatalytic activity of the mixture. A comparison of this slope with that for the aqueous disodium terephthalate solution provided the relative photoactivity of the granules as reported. In general, the larger the reported value, the greater the photoactivity of the granules.

### Working Examples 1-3

Blank red granules were prepared as follows. 43.02 g of sodium silicate (Sodium Silicate PD, available from PQ Corporation, Valley Forge, Pa.), 16.00 g of deionized water, 6.57 g of Red Iron Oxide M201Y (available from Revelli Chemicals, Greenwich, Conn.), 4.13 g of Red Iron Oxide RO-5097 (available from Harcros Chemicals, Kansas City, Kans.), and 10.95 g of Dover Clay (available from Grace Davison, Columbia, Mass.) were added to a 250 mL vessel and well mixed. The resulting mixture was then slowly poured onto 1000 g of stirring Grade #11 uncoated granules (available from 3M Company, St. Paul, Minn.), which had been pre-heated to 210° F. (˜99° C.) for one hour. While pouring, the granules were mixed to ensure an even coating. The granules were further stirred for about 2 minutes and then heated with a heat gun until they appeared to be dry and loose. The dried granules were then fired in a rotary kiln (natural gas/oxygen flame) to 800° F. (˜427° C.), and removed and allowed to cool to room temperature.

The red granules with photocatalytic coating for Working Example 1 were prepared as follows. 0.34 g of potassium silicate (Kasil 1, available from PQ Corporation), 0.51 g of aqueous dispersion of TiO₂ (STS-21, available from Ishihara Sangyo Kaisha, Japan), and 40.79 g of deionized water were added to a 250 mL vessel and well mixed. The resulting mixture was then slowly poured onto stirring blank red granules prepared as described above, which had been pre-heated to 210° F. for one hour. While pouring, the granules were mixed to ensure an even coating. The granules were further stirred for about 2 minutes and then heated with a heat gun until they appeared to be dry and loose. The dried granules were then fired in a rotary kiln (natural gas/oxygen flame) to 800° F., and removed and allowed to cool to room temperature. The red granules with photocatalytic coating for Working Examples 2 & 3 were prepared using the same procedure except that different coating compositions were used. The compositions of the photocatalytic coatings for Working Examples 1-3 are listed in Table 1. The mean cluster size of the STS-21 dispersion was measured as about 220 nm according to the testing procedure described above.

The L*, a*, b* numbers and photocatalytic activity for the red granules with photocatalytic coating were measured according to the testing procedures described above, and reported in Table 1. For comparison, the L*, a*, b* numbers and photocatalytic activity for the blank red granules were also measured and reported in Table 1. The results show that the use of a TiO₂ dispersion having a relatively small mean cluster size produces photocatalytic coatings that have minimal impact on color and exhibit desirable photoactivity.

TABLE 1
Compositions of Photocatalytic Coatings, L*, a*, b* Numbers
and Photocatalytic Activity for Working Examples 1-3.

| | Kasil 1 | STS-21 | DI H₂O | Firing Temp | | | | |
|---|---|---|---|---|---|---|---|---|
| Example | (g) | (g) | (g) | (° F.) | L* | a* | b* | Photoactivity |
| 1 | 0.34 | 0.51 | 40.79 | 800 | 31.03 | 21.68 | 17.71 | 1.7 × 10⁴ |
| 2 | 0.36 | 1.03 | 40.33 | 800 | 31.05 | 22.18 | 17.46 | 7.1 × 10⁴ |
| 3 | 0.70 | 0.99 | 40.73 | 800 | 31.11 | 21.62 | 17.48 | 3.7 × 10⁴ |

| | | | | |
|---|---|---|---|---|
| Blank Red Granules | 31.14 | 22.51 | 17.88 | 1.4 × 10³ |

### Working Examples 4-6

Blank olive granules were prepared using the same procedure as that for preparing the blank red granules in Working Examples 1-3 except that a different coating composition was used. Specifically, the coating composition was made by adding 35.37 g of Sodium Silicate PD, 13.67 g of deionized water, 6.10 g of Mapico Tan Iron Oxide 10A (available from Rockwood Pigments, Beltsville, Md.), 0.53 g of Carbon Black M-8452 (available from Rockwood Pigments), 2.64 g of Burnt Umber L1361 (available from Rockwood Pigments), 1.70 g of Chromium Oxide 112 (available from Elementis Chromium, Corpus Christi, Tex.), and 8.13 g of Dover Clay (available from Grace Davison, Columbia, Mass.) to a 250 mL vessel, followed by well mixing.

The olive granules with photocatalytic coating for Working Examples 4-6 were prepared using the same procedure as that for preparing the red granules with photocatalytic coating for Working Example 1 except that different coating compositions were used and the granules used were blank olive granules instead of blank red granules. The compositions of the photocatalytic coatings for Working Examples 4-6 are listed in Table 2.

The L*, a*, b* numbers and photocatalytic activity for the olive granules with photocatalytic coating were measured according to the testing procedures described above, and reported in Table 2. For comparison, the L*, a*, b* numbers and photocatalytic activity for the blank olive granules were also measured and reported in Table 2. The results also show that the use of a TiO₂ dispersion having a relatively small mean cluster size produces photocatalytic coatings that have minimal impact on color and exhibit desirable photoactivity.

TABLE 2
Compositions of Photocatalytic Coatings, L*, a*, b* Numbers
and Photocatalytic Activity for Working Examples 4-6.

| | Kasil 1 | STS-21 | DI H₂O | Firing Temp | | | | |
|---|---|---|---|---|---|---|---|---|
| Example | (g) | (g) | (g) | (° F.) | L* | a* | b* | Photoactivity |
| 4 | 0.36 | 0.51 | 40.42 | 800 | 28.39 | 1.63 | 8.51 | 8.3 × 10³ |
| 5 | 0.37 | 1.00 | 40.35 | 800 | 27.95 | 1.92 | 7.84 | 1.1 × 10⁵ |
| 6 | 0.71 | 1.02 | 40.02 | 800 | 28.13 | 1.97 | 8.09 | 6.7 × 10⁴ |

| | | | | |
|---|---|---|---|---|
| Blank Olive Granules | 28.23 | 2.03 | 9.71 | 2.4 × 10³ |

The tests and test results described above are intended solely to be illustrative, rather than predictive, and variations in the testing procedure can be expected to yield different results. The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A coated article, comprising:
an article having an external surface and a coating on the external surface of the article, wherein the coating is formed from a composition comprising a dispersion of photocatalysts having a mean cluster size of less than about 300 nm and an alkali metal silicate binder.

2. The coated article of claim 1, wherein the article is a roofing granule.

3. The coated article of claim 1, wherein the article is a tile.

4. The coated article of claim 1, wherein the photocatalysts comprise TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

5. The coated article of claim 1, wherein the photocatalysts comprise crystalline anatase TiO₂, crystalline rutile TiO₂, crystalline ZnO, or combinations thereof.

6. The coated article of claim 1, wherein the photocatalysts are doped with C, N, S, F, Pt, Pd, Au, Ag, Os, Rh, RuO₂, Nb, Cu, Sn, Ni, Fe, or combinations thereof.

7. The coated article of claim 1, wherein the alkali metal silicate binder comprises lithium silicate, sodium silicate, potassium silicate, or combinations thereof.

8. The coated article of claim 1, wherein the alkali metal silicate binder comprises a pigment.

9. The coated article of claim 1, wherein each of the absolute values of the difference in the L*, a*, b* numbers between the coated article and the base article is less than about 2.

10. A coated roofing granule, comprising:
a roofing granule having an external surface and a coating on the external surface of the roofing granule, wherein the coating is formed from a composition comprising a dispersion of photocatalysts having a mean cluster size of less than about 300 nm and an alkali metal silicate binder, and wherein each of the absolute values of the difference in the L*, a*, b* numbers between the coated granule and the base granule is less than about 2.

11. A coating composition, comprising:
a dispersion of photocatalyts having a mean cluster size of less than about 300 nm and an alkali metal silicate binder.

12. The coating composition of claim 11, wherein the photocatalysts comprise TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

13. The coating composition of claim 11, wherein the photocatalysts comprise crystalline anatase TiO₂, crystalline rutile TiO₂, crystalline ZnO, or combinations thereof.

14. The coating composition of claim 11, wherein the photocatalysts are doped with C, N, S, F, Pt, Pd, Au, Ag, Os, Rh, RuO₂, Nb, Cu, Sn, Ni, Fe, or combinations thereof.

15. The coating composition of claim 11, wherein the alkali metal silicate binder comprises lithium silicate, sodium silicate, potassium silicate, or combinations thereof.

16. The coating composition of claim 11, wherein the alkali metal silicate binder comprises a pigment.

17. A method of making a coated article, comprising:
providing an article having an external surface, providing a composition comprising a dispersion of photocatalysts having a mean cluster size of less than about 300 nm and an alkali metal silicate binder, depositing the composition onto the article, and heating the deposited article to form a coating thereon.

18. The method of claim 17, wherein the article is a roofing granule.

19. The method of claim 17, wherein the article is a tile.

20. The method of claim 17, wherein the photocatalysts comprise TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

21. The method of claim 17, wherein the photocatalysts comprise crystalline anatase TiO₂, crystalline rutile TiO₂, crystalline ZnO, or combinations thereof.

22. The method of claim 17, wherein the photocatalysts are doped with C, N, S, F, Pt, Pd, Au, Ag, Os, Rh, RuO₂, Nb, Cu, Sn, Ni, Fe, or combinations thereof.

23. The method of claim 17, wherein the alkali metal silicate binder comprises lithium silicate, sodium silicate, potassium silicate, or combinations thereof.

24. The method of claim 17, wherein the alkali metal silicate binder comprises a pigment.

25. The method of claim 17, wherein each of the absolute values of the difference in the L*, a*, b* numbers between the coated article and the base article is less than about 2.

26. A method of making a coated roofing granule, comprising:
providing a roofing granule having an external surface, providing a composition comprising a dispersion of photocatalysts having a mean cluster size of less than about 300 nm and an alkali metal silicate binder, depositing the composition onto the roofing granule, and heating the deposited roofing granule to form a coating thereon, wherein each of the absolute values of the difference in the L*, a*, b* numbers between the coated granule and the base granule is less than about 2.
